(19) United States
(12) Patent Application Publication
(10) Pub. No.: US 2026/0118696 A1
(43) Pub. Date: Apr. 30, 2026

(54) TEMPLE CONNECTION STRUCTURE AND HEAD-MOUNTED DISPLAY DEVICE

(71) Applicant: GOERTEK INC., Weifang (CN)

(72) Inventors: Xiongchun DU, Weifang (CN); Yaocheng LIU, Weifang (CN); Chao ZHANG, Weifang (CN); Xiangdong LAN, Weifang (CN); Chuanlong LI, Weifang (CN)

(21) Appl. No.: 19/433,571

(22) Filed: Dec. 26, 2025

Related U.S. Application Data
(63) Continuation of application No. PCT/CN2024/137151, filed on Dec. 5, 2024.

(30) Foreign Application Priority Data
Jun. 26, 2024 (CN) 202410844086.X

(51) Int. Cl. G02C 5/22; G02B 27/01

(52) U.S. Cl. CPC G02C 5/2218; G02B 27/0176

(57) ABSTRACT

A temple connection structure includes a first bracket, a second bracket, a first elastic member and a limiting member. the first bracket and the second bracket are rotatably connected to each other, one of the first bracket and the second bracket is mounted at the temple and the other of the first bracket and the second bracket is mounted at the frame; the first elastic member is provided at the first bracket; the limiting member is provided at the second bracket and is provided with a limiting part; during a process of the temple flipping outward from an open position, the limiting part pushes against the first elastic member and causes the first elastic member to be in an elastic deformation state.

### CROSS-REFERENCE TO RELATED APPLICATIONS

This application claims is a continuation application of International Application No. PCT/CN2024/137151, filed on Dec. 5, 2025, which claims priority to Chinese Patent Application No. 202410844086.X, filed on Jun. 26, 2024. All of the aforementioned applications are incorporated herein by reference in their entireties.

### TECHNICAL FIELD

The present application relates to the technical field of head-mounted display devices, and in particular to a temple connection structure and a head-mounted display device.

### BACKGROUND

Current head-mounted display devices, such as but not limited to augmented reality (AR) glasses, virtual reality (VR) glasses, and mixed reality (MR) glasses, typically use a simple hinge structure between the temples and the frame. When worn by users with larger head circumferences, the temples tend to fold outwards, forming an outward V-shape. In addition, the temples have weak clamping force on the user's head, causing the device to easily slip forward.

### SUMMARY

The main objective of the present application is to propose a temple connection structure and a head-mounted display device, which aims to reduce the risk of the temples and head-mounted display device slipping forward.

To achieve the above objectives, the present application proposes a temple connection structure for connecting the temples and the frame, and the temple connection structure includes:
a first bracket;
a second bracket rotatably connected to the first bracket;
a first elastic member provided at the first bracket; and
a limiting member provided at the second bracket and provided with a limiting part,
one of the first bracket and the second bracket is mounted at the temple and the other of the first bracket and the second bracket is mounted at the frame; and
during a process of the temple flipping outward from an open position, the limiting part pushes against the first elastic member and causes the first elastic member to be in an elastic deformation state.

In an embodiment, the first bracket and the second bracket rotate relative to each other around a first axis, and an elastic deformation direction of the first elastic member intersects with the first axis.

In an embodiment, the first elastic member and the limiting member are provided at a side of the first axis, the first bracket and the second bracket form a mounting channel at the first axis, and the mounting channel is configured for a functional member to extend from the frame to the temple.

In an embodiment, during a process of the temple flipping inward from the open position, the limiting part disengages from the first elastic member, and a clearance space is formed between the first elastic member and the limiting part; the clearance space is communicated with the mounting channel, and the functional member is partially accommodated in the clearance space.

In an embodiment, the first elastic member includes a mounting part, a deformation part and a pushed part connected in sequence, the mounting part is connected to the first bracket, and the pushed part moves toward the mounting part under a pushing action of the limiting part, and causes the deformation part to elastically deform.

In an embodiment, a plane where a midpoint connecting line of the deformation part is located is parallel to the first axis, the limiting member further includes two cantilever parts intersecting with each other, first ends of the two cantilever parts are respectively connected to different positions of the first bracket, second ends of the two cantilever parts are connected to each other and connected to the limiting part, and the two cantilever parts and the limiting part are provided at the plane.

In an embodiment, the deformation part includes a first deformation structure and a second deformation structure connected to the first deformation structure, the first deformation structure is connected to the mounting part, the second deformation structure is connected to the pushed part, and the process of the temple flipping outward from the open position includes a first stage and a second stage occurring sequentially; in the first stage, the first deformation structure deforms while the second deformation structure does not deform; in the second stage, the first deformation structure and the second deformation structure deform, and elastic forces applied to the pushed part by the first deformation structure and the second deformation structure are provided in opposite directions to keep an amplitude fluctuation of a clamping force of the temple within a preset percentage.

In an embodiment, the first deformation structure includes a force-bearing rod segment and two bending rod segments, the two bending rod segments are respectively provided at opposite ends of the force-bearing rod segment, the force-bearing rod segment is opposite to the mounting part, and one end of the bending rod segment is connected to an end of the force-bearing rod segment, and the other end of the bending rod segment is connected to an end of the mounting part; the second deformation structure includes a main rod segment and two side wing rod segments, the main rod segment is connected between the pushed part and a middle of the force-bearing rod segment; the two side wing rod segments are respectively provided at opposite sides of the main rod segment, the side wing rod segments extend obliquely away from the main rod segment along a direction close to the force-bearing rod segment, and an end of the side wing rod segment away from the main rod segment is adjacent to the force-bearing rod segment.

In an embodiment, the first axis, the deformation part includes a first arc-shaped rod segment and a second arc-shaped rod segment, protrusions of the first arc-shaped rod segment and second arc-shaped rod segment are in opposite directions, the first arc-shaped rod segment is connected to the mounting part, and the second arc-shaped rod segment protrudes toward the first axis; when the temple is in the open position, an end of the second arc-shaped rod segment away from the first arc-shaped rod segment is abutted against the limiting part.

In an embodiment, a second elastic member is provided between the first bracket and the second bracket, the second elastic member elastically deforms along a rotation axis of the first bracket, and is in the elastic deformation state at least during a process of the temple flipping inward from the open position.

The present application further provides a head-mounted display device, including:
a frame;
temples; and
a temple connection structure as described above,
the temples are mounted at the frame through the temple connection structure.

In an embodiment, when the temple is in an open position, a clearance gap is formed between the temple and the frame, and the head-mounted display device further includes a cover provided in the clearance gap to cover at least a portion of the temple connection structure exposed in the clearance gap.

In the technical solution of the present application, the outward flipping of the temple from the open position causes the second bracket to rotate relative to the first bracket and around the first axis, and causes the limiting member to push against the first elastic member, so that the first elastic member is in an elastic deformation state. The first elastic member in the elastic deformation state will generate a reaction force on the limiting member, and the reaction force is transmitted to the temple through the limiting member and the second bracket, thereby causing the temple to have a tendency to rotate toward the open position. It can be understood that the tendency of the temple to rotate toward the open position can increase the clamping force on the user's head when the temple is worn. The clamping force is conducive to the stable and reliable wearing of the eyeglasses. In this way, the temple can fit well on the head and reduce the risk of the temple and head-mounted display device slipping forward.

### BRIEF DESCRIPTION OF THE DRAWINGS

To more clearly illustrate the technical solutions in the embodiments of the present application or the related art, the drawings used in the description of the embodiments or the related art will be briefly introduced below. Obviously, the drawings described below are only some embodiments of the present application. For those skilled in the art, other drawings can be obtained based on the structures shown in these drawings without creative effort.

FIG. 1 is a schematic view of a temple connection structure according to an embodiment of the present application where a temple is in an open position.

FIG. 2 is a front view of the temple connection structure shown in FIG. 1.

FIG. 3 is a top view of the temple connection structure shown in FIG. 2.

FIG. 4 is a cross-sectional view at a portion A-A in FIG. 2, where the temple is at a outward limit position.

FIG. 5 is a schematic view of the temple connection structure shown in FIG. 1, where the temple is in a process of flipping inward from the open position.

FIG. 6 is a schematic view of the temple connection structure according to an embodiment of the present application, where the temple is in the open position.

FIG. 7 is a front view of the temple connection structure shown in FIG. 6.

FIG. 8 is a schematic view of the temple connection structure according to an embodiment of the present application, where the temple is in the open position.

FIG. 9 is an exploded view of the temple connection structure shown in FIG. 8 applied to a head-mounted display device according to an embodiment of the present application.

FIG. 10 is a cross-sectional view of the structure shown in FIG. 9 on a section perpendicular to a first axis.

FIG. 11 is a schematic view of the structure shown in FIG. 9, where the temple is at the outward limit position.

FIG. 12 is a graph of a relationship between a clamping force and an outward angle of the temple.

The realization of the purpose, functional features and advantages of the present application will be further explained in conjunction with the embodiments and with reference to the accompanying drawings.

### DETAILED DESCRIPTION OF THE EMBODIMENTS

The technical solutions of the embodiments of the present application will be clearly and completely described below with reference to the accompanying drawings. Obviously, the described embodiments are only a part of the embodiments of the present application, and not all of the embodiments. Based on the embodiments of the present application, all other embodiments obtained by those skilled in the art without creative effort are within the scope of the present application.

It should be noted that if the embodiments of the present application involve directional indicators (such as up, down, left, right, front, back, etc.), the directional indicators are only used to explain the relative positional relationship and movement of the components in a specific posture. If the specific posture changes, the directional indicators will also change accordingly.

Furthermore, if the embodiments of the present application involve descriptions such as “first” or “second”, these descriptions are for descriptive purposes only and should not be construed as indicating or implying their relative importance or implicitly specifying the number of technical features indicated. Therefore, a feature defined with “first” or “second” may explicitly or implicitly include at least one of those features. Additionally, the use of “and/or” or “and/or” throughout the text includes three parallel solutions. For example, “A and/or B” includes solution A, solution B, or a solution that simultaneously satisfies A and B. Furthermore, the technical solutions of the various embodiments can be combined with each other, but this must be based on the ability of those skilled in the art to implement them. When the combination of technical solutions is contradictory or impossible to implement, it should be considered that such a combination of technical solutions does not exist and is not within the scope of protection claimed in the present application.

Current head-mounted display devices, such as but not limited to augmented reality (AR) glasses, virtual reality (VR) glasses, and mixed reality (MR) glasses, typically use a simple hinge structure for the connection between the temples and the frame. When worn by users with larger head circumferences, the temples tend to fold outwards, forming an outward V-shape. In addition, the temples have weak clamping force on the user's head, causing the device to easily slip forward.

The present application proposes a temple connection structure for connecting the temples and the frames. The temples of the head-mounted display device can be mounted at the frame through the temple connection structure, enabling the temples to generate a clamping force when worn, thus securing them to the user's head and improving the wearing stability of the head-mounted display device. The head-mounted display device includes, but is not limited to, AR glasses, VR glasses, and MR glasses. Taking AR glasses as an example, their frames typically include a display module to provide image information to the user's eyes.

It should be noted that as the temples gradually unfold from the folded state, they pass through the folded position, the open position, and the outward limit position in sequence. When in the folded position, the free end of the temple is close to or abutted against the frame. When in the open position or the outward limit position, the free end of the temple is far away from the frame. The temples have a plurality of wearing states from the open position to the outward limit position to allow users with different head sizes to wear them normally.

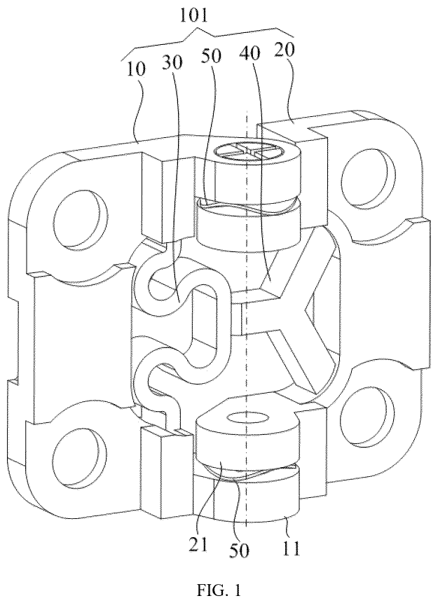

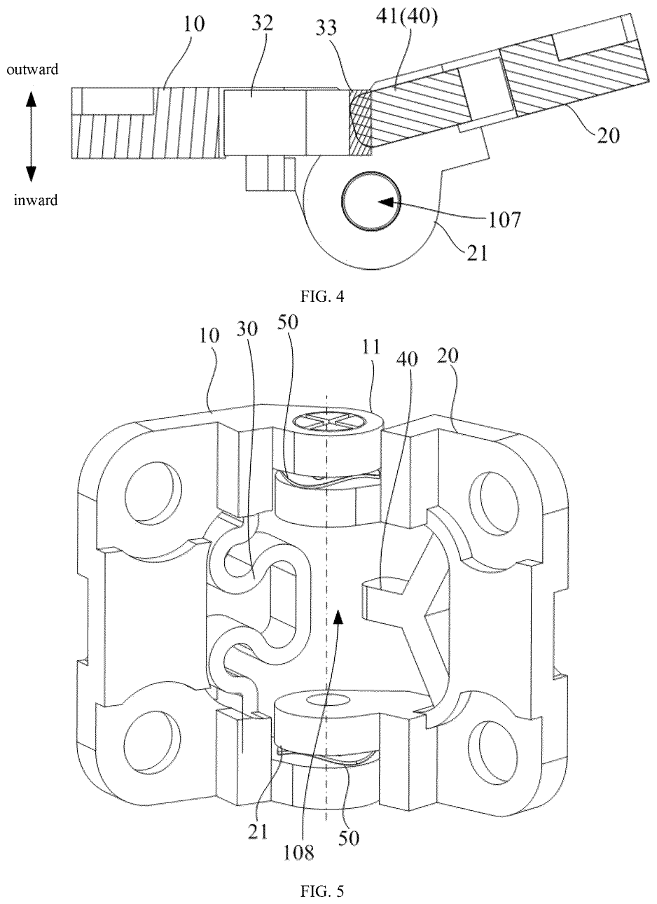

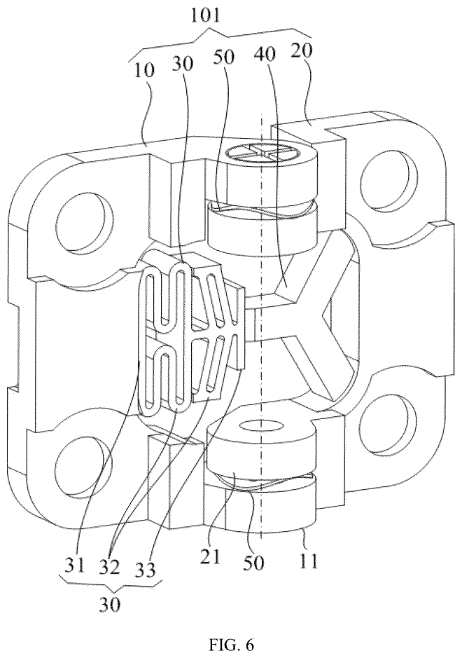

As shown in FIG. 1 to FIG. 11, FIG. 1 to FIG. 3 and FIG. 6 to FIG. 10 correspond to the state where the temples are in the open position, FIG. 4 and FIG. 1 correspond to the state where the temples are in the outward limit position, and FIG. 5 corresponds to the process state where the temples are inwardly flipping from the open position.

As shown in FIG. 1 to FIG. 5, in an embodiment of the present application, the temple connection structure 101 is configured for connecting the temple 102 and the frame 103. The temple connection structure 101 includes a first bracket 10, a second bracket 20, a first elastic member 30 and a limiting member 40.

The first bracket 10 and the second bracket 20 are rotatably connected to each other, one of the first bracket 10 and the second bracket 20 is mounted at the temple 102 and the other the first bracket 10 and the second bracket 20 is mounted at the frame 103.

The first elastic member 30 is provided at the first bracket 10.

The limiting member 40 is provided at the second bracket 20 and is provided with a limiting part 41.

During the process of the temple 102 flipping outward from the open position, the limiting part 41 pushes against the first elastic member 30 and causes the first elastic member 30 to be in an elastic deformation state.

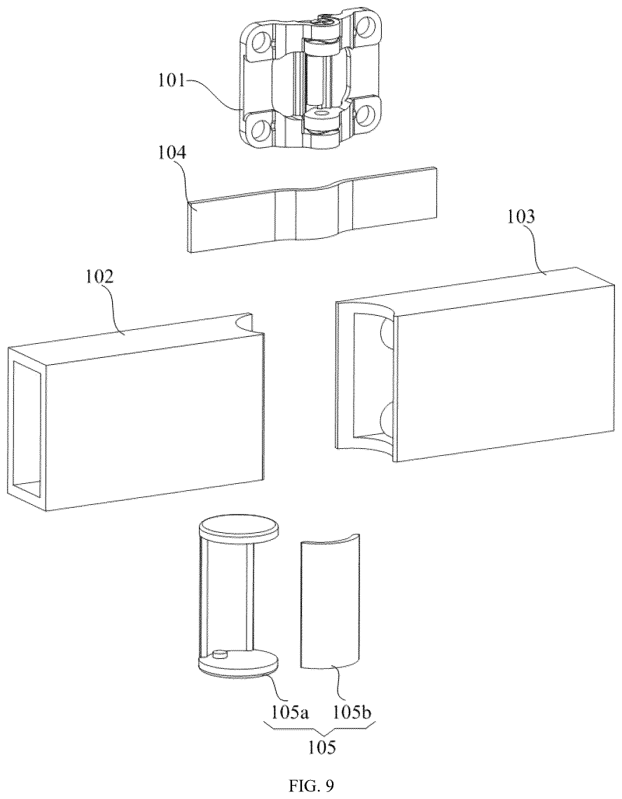

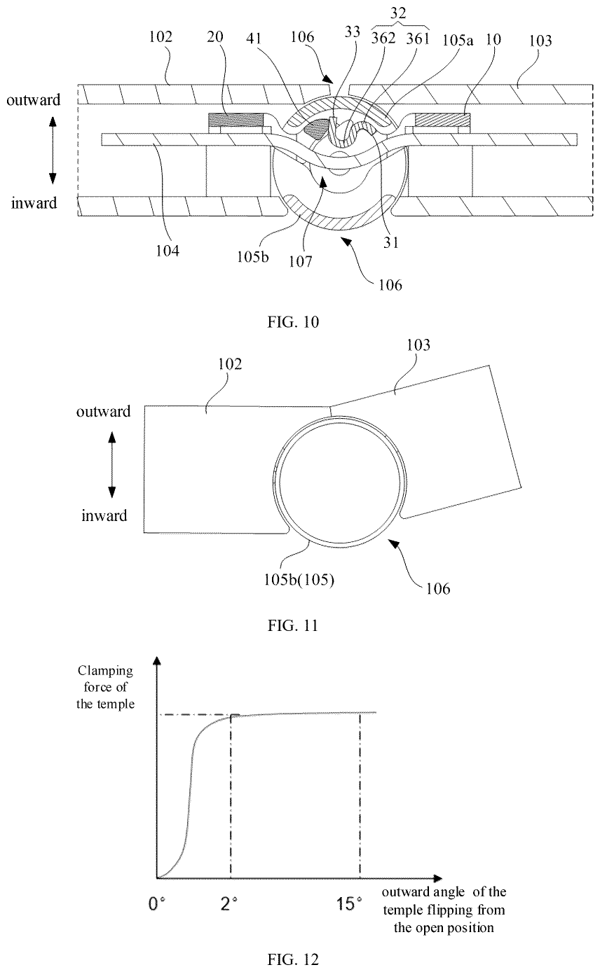

As shown in FIG. 9 and FIG. 10, in the embodiments, the first bracket 10 is provided at the frame 103, and the second bracket 20 is provided at the temple 102. It can be understood that in the embodiment, the folded position of the second bracket 20 corresponds to the folded position of the temple 102, the open position of the second bracket 20 corresponds to the open position of the temple 102, and the outward limit position of the second bracket 20 corresponds to the outward limit position of the temple 102. Therefore, the process of the second bracket 20 flipping outward from the open position corresponds to the process of the temple 102 flipping outward from the open position. In an embodiment, the first bracket 10 may be provided at the temple 102, and the second bracket 20 may be provided at the frame 103.

For ease of explanation, the following description will take an embodiment in which the first bracket 10 is provided at the frame 103 and the second bracket 20 is provided at the temple 102 as an example.

In the technical solution of the present application, the temple 102 flipping outward from the open position causes the second bracket 20 and the first bracket 10 rotate relative to each other around a first axis, and causes the limiting member 40 to push against the first elastic member 30, so that the first elastic member 30 is in an elastic deformation state. The first elastic member 30 in the elastic deformation state will generate a reaction force on the limiting member 40, which is transmitted to the temple 102 via the limiting member 40 and the second bracket 20, thereby causing the temple 102 to have a tendency to rotate toward the open position. It can be understood that the tendency of the temple 102 to rotate toward the open position can increase the clamping force of the temple 102 on the user's head when worn. The clamping force is conducive to the stable and reliable wearing of the eyeglasses. In this way, the temple 102 can fit well on the head and reduce the risk of the temple 102 and the head-mounted display device slipping forward.

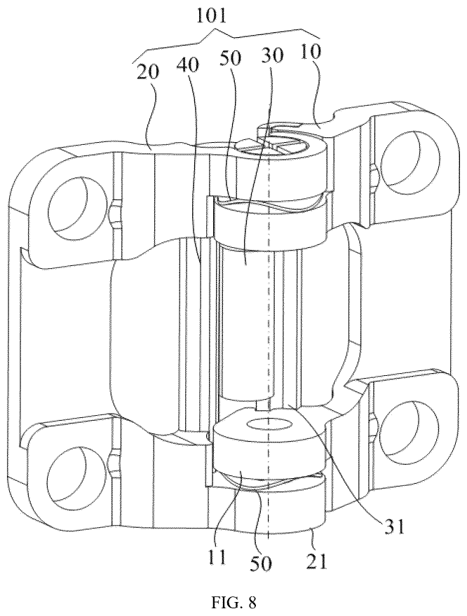

As shown in FIG. 1, FIG. 6, and FIG. 8, in some embodiments, the first bracket 10 and the second bracket 20 rotate relative to each other around the first axis, and the elastic deformation direction of the first elastic member 30 intersects with the first axis. It should be noted that the elastic deformation direction of the first elastic member 30 refers to the direction in which the first elastic member 30 is subjected to the force of the limiting member 40. The elastic deformation direction is generally parallel to the direction where the first elastic member 30 has the maximum deformation. It can be understood that since the elastic deformation direction of the first elastic member 30 intersects with the first axis, that is, the elastic deformation direction of the first elastic member 30 is substantially parallel to the plane on which the movement trajectory of the temple 102 is located, the reaction force of the first elastic member 30 can directly affect the outward flipping of the temple 102 and form a clamping force on the temple 102. Thus, the interaction between the first elastic member 30 and the limiting member 40 is direct and clear, and the structural features of the temple connection structure 101 can be simplified.

In an embodiment, the elastic deformation direction of the first elastic member 30 can be parallel or substantially parallel to the first axis. That is, the elastic deformation direction of the first elastic member 30 is substantially perpendicular to the plane on which the movement trajectory of the temple 102 is located.

As shown in FIG. 3, FIG. 4, and FIG. 10, in some embodiments, the first elastic member 30 and the limiting member 40 are provided at a side of the first axis, and the first bracket 10 and the second bracket 20 form a mounting channel 107 at the first axis. The mounting channel 107 is configured for the functional member 104 to extend from the frame 103 to the temple 102. That is, the head-mounted display device of the embodiment further includes the functional member 104, the functional member 104 includes at least one of a wiring harness, a flexible printed circuit board, and a flexible thermal conductive component. Electronic components (e.g., rechargeable batteries) on the temple 102 and electronic components (opto-mechanical module) on the frame 103 are electrically connected through the functional member 104. The following description will use a flexible printed circuit board as an example.

Thus, the mounting channel 107 provided for the functional member 104 facilitates the mounting and use of the functional member 104, while also reducing the weight of the temple connection structure 101. The mounting channel 107 is provided at the first axis. On one hand, this allows the flexible printed circuit board (PCB) to pass through the rotation center of the temple connection structure 101, significantly reducing the length variation of the PCB during the relative rotation of the first bracket 10 and the second bracket 20, thereby reducing the risk of PCB bending. On the other hand, the mounting channel 107 provides ample clearance, allowing the PCB have greater freedom of movement and a larger bending radius during bending, thereby further reducing the risk of PCB bending and extending the service life of the device. Furthermore, it reduces the thickness of the temple connection structure 101.

As shown in FIG. 4 and FIG. 10, in some embodiments, the first axis is provided at the side of the first elastic member 30 close to the inner side of the temple 102. It should be noted that the inner side of the temple 102 refers to the side facing the frame 103 when it is in the folded position. That is, the side facing the user's head when the temple 102 is worn. This facilitates the displacement and deformation (expansion or contraction) of the flexible printed circuit board within the mounting channel 107, thereby further reducing the risk of PCB bending. In an embodiment, the first axis may also be provided at the side of the first elastic member 30 away from the inner side of the temple 102.

As shown in FIG. 1, FIG. 6, and FIG. 8, in some embodiments, the first bracket 10 includes two opposing first rotating portions 11 on its side toward the second bracket 20, and the second bracket 20 includes two opposing second rotating portions 21. The first rotating portions 11 and the second rotating portions 21 are hinged to achieve a rotatable connection between the first bracket 10 and the second bracket 20. One of the first rotating portion 11 and the second rotating portion 21, which is closer to the limiting part 41 defines the mounting channel 107. For example, in the embodiment shown in FIG. 8, the first rotating portion 11 is closer to the limiting part 41, and the mounting channel 107 is formed between the two first rotating portions 11. In the embodiment shown in FIG. 1, the second rotating portion 21 is closer to the limiting part 41, and the mounting channel 107 is formed between the two second rotating portions 21.

As shown in FIG. 5, in an embodiment, during the process of the temple 102 flipping inward from the open position, the limiting part 41 disengages from the first elastic member 30. Thus, during the flipping process of the temple 102, the elastic member does not exert force on the temple 102, making the flipping of the temple 102 smoother and less strenuous. In an embodiment, the limiting part 41 is continuously abutted against the first elastic member 30 during the process of the temple 102 flipping inward from the open position.

As shown in FIG. 5, in an embodiment, during the process of the temple 102 flipping inward from the open position, a clearance space 108 is formed between the limiting member 40 and the first elastic member 30. The clearance space 108 is communicated with the mounting channel 107, and the functional member 104 is partially accommodated in the clearance space 108. Thus, during the process of the temple 102 rotating from the open position to the folded position, the clearance space 108 is configured to accommodate and store the excessively long part of the flexible printed circuit board, thereby helping to improve the service life of the device. In an embodiment, the clearance space 108 may not be provided, or the limiting member 40 is continuously abutted against the first elastic member 30.

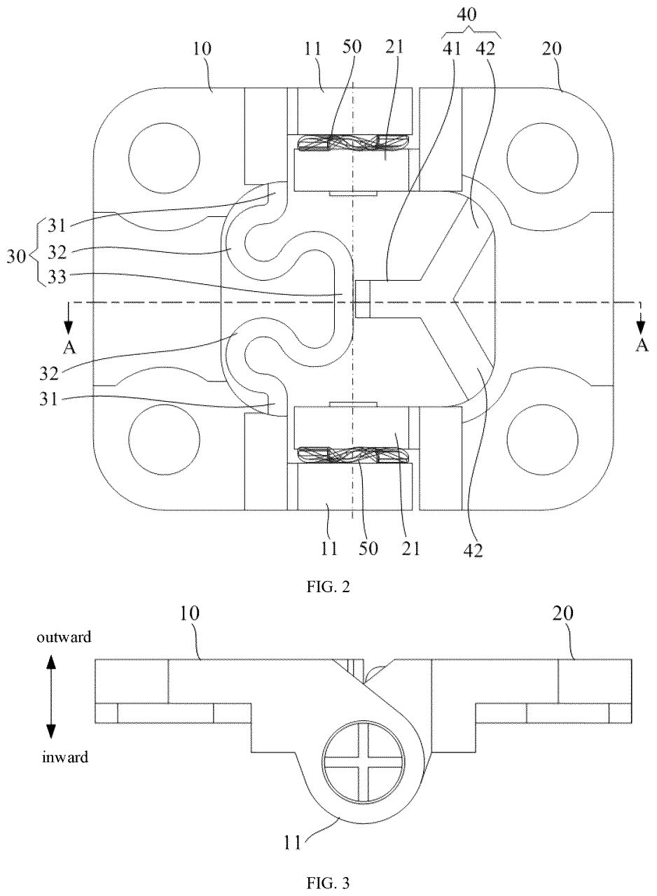

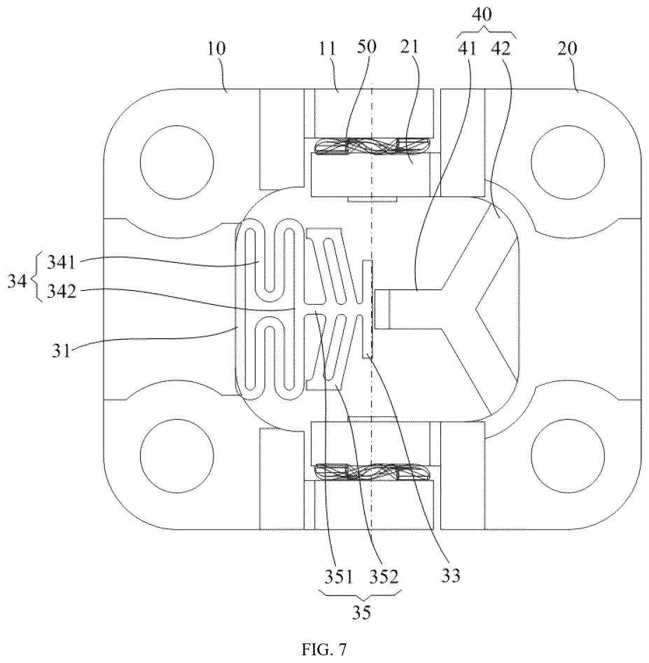

It is understood that the structure of the first elastic member 30 can be varied. For example, as shown in FIG. 2, FIG. 7, and FIG. 10, in some embodiments, the first elastic member 30 further includes a mounting part 31, a deformation part 32, and a pushed part 33 connected in sequence. The mounting part 31 is connected to the first bracket 10. The pushed part 33 moves toward the mounting part 31 under the pushing action of the limiting member 40, and causes the deformation part 32 to elastically deform. Thus, the structure is simple and easy to implement. In an embodiment, the first elastic member 30 can also be configured as a spring or a silicone pillar, etc., and its overall structure may be elastically deformable.

As shown in FIG. 2 and FIG. 7, in some embodiments, the plane where the midpoint connecting line of the deformation part 32 is parallel to the first axis. The limiting member 40 further includes two cantilever parts 42 intersecting with each other. The first ends of the two cantilever parts 42 are respectively connected to different positions of the first bracket 10, and the second ends of the two cantilever parts 42 are connected to each other and connected to the limiting part 41. The cantilever parts 42 and the limiting part 41 are provided at the plane.

It should be noted that “parallel” refers to a state of parallelism or near-parallelism. The deformation part 32 can be cut into a plurality of cross-sections along a direction perpendicular to its own bending direction. The line connecting the midpoints of the plurality of cross-sections is the midpoint connecting line of the deformation part 32. Thus, the deformation part 32, the cantilever part 42, and the limiting part 41 are provided in the plane where the midpoint connecting line of the deformation part 32 is located, and the deformation part 32, the cantilever part 42, and the limiting part 41 are parallel to the first axis. This helps to reduce the width of the deformation part 32 and the limiting member 40 in the thickness direction of the temple connection structure 101, thereby facilitating the thinner design of the temple connection structure 101 and the temple 102. In an embodiment, the plane where the midpoint connecting line of the deformation part 32 is located intersects with the first axis, as in the embodiment shown in FIG. 10.

To improve the connection strength between the first elastic member 30 and the first bracket 10, in some embodiments, the mounting part 31 is welded to the first bracket 10, and the cantilever part 42 is welded to the first bracket 10. In other embodiments, only the mounting part 31 or only the cantilever part 42 may be welded to the first bracket 10.

In an embodiment, during the process of the temple 102 flipping outward within a preset outward angle, the amplitude fluctuation of the clamping force of the temple 102 remains within a preset percentage. That is, the clamping force of the temple 102 will not increase significantly with the increase of the outward angle of the temple 102, so that the clamping force remains basically constant when the temple 102 is flipped outward. In other words, the clamping force of the temple 102 is more stable when worn, thus avoiding excessive clamping force on users with larger head circumferences and ensuring consistent wearing comfort for people with different head circumferences, thereby improving the wearing comfort of the temple 102.

In an embodiment, the preset outward angle is configured to be between 2° and 15°, and the preset percentage is configured to be 10%. That is, within the outward angle range of 2° to 15° from the open position of the temple 102, the amplitude fluctuation of the clamping torque remains within 10%. For example, taking the clamping torque M=200N*mm as an example, the numerical change can be controlled between 180N*mm and 220N*mm, so the handling feel and wearing comfort of the temple 102 are quite ideal. In an embodiment, the preset outward angle can also be configured to other values, such as 1°, 17°, 19° or 20°, etc. The preset percentage can also be configured to other values, such as 5%, 7% or 13%, etc.

It is understood that there are multiple ways to achieve the effect of keeping the clamping force basically constant when the temple 102 is flipped outward. For example, as shown in FIG. 6 and FIG. 7, in an embodiment, the deformation part 32 includes a first deformation structure 34 and a second deformation structure 35 connected to each other. The first deformation structure 34 is connected to the mounting part 31, and the second deformation structure 35 is connected to the pushed part 33. The process of the temple 102 flipping outward from the open position includes a first stage and a second stage occurring sequentially. In the first stage, the first deformation structure 34 deforms while the second deformation structure 35 does not deform. In the second stage, the first deformation structure 34 and the second deformation structure 35 deform, and the elastic forces applied to the pushed part 33 by the first deformation structure 34 and the second deformation structure 35 are provided in opposite directions to keep the amplitude fluctuation of the clamping force of the temple 102 within a preset percentage.

As shown in FIG. 12, the first stage of the temple 102 flipping outward from the open position corresponds to the stage where the curve rises sharply in FIG. 12. At this time, only the first deformation structure 34 undergoes elastic deformation. As the outward angle of the temple 102 increases, the deformation of the first deformation structure 34 gradually increases, and the elastic force exerted by the first deformation structure 34 on the pushed part 33 gradually increases. As a result, the reaction force generated by the pushed part 33 on the limiting member 40 also gradually increases, which ultimately manifests as the clamping force of the temple 102 gradually increasing. The second stage of the temple 102 flipping outward from the open position corresponds to the stage in FIG. 12 where the curve is relatively flat (the clamping force value is basically constant). At this time, the first deformation structure 34 and the second deformation structure 35 undergo elastic deformation. The elastic force (defined as the first force) generated by the first deformation structure 34 on the pushed part 33 continues to increase. However, since the elastic force (defined as the second force) generated by the second deformation structure 35 on the pushed part 33 is opposite to the force direction of the first force, and the first force is also gradually increasing, it is equivalent to a part of the force of the first force being continuously canceled by the second force. Thus, the total force composed of the first force and the second force is maintained at a certain value, or fluctuates slightly around that value. Ultimately, the clamping force of the temple 102 flipping outward is constant. That is, the amplitude fluctuation of the clamping force of the temple 102 is kept within a preset percentage.

As shown in FIG. 7, in an embodiment, the first deformation structure 34 further includes a force-bearing rod segment 341 and two bending rod segments 342, the two bending rod segments 342 are respectively provided at opposite ends of the force-bearing rod segment 341. The force-bearing rod segment 341 the mounting part 31, and one end of the bending rod segment 342 is connected to the end of the force-bearing rod segment 341 and the other end of the bending rod segment 342 is connected to the end of the mounting part 31. The second deformation structure 35 includes a main rod segment 351 and two side wing rod segments 352. The main rod segment 351 is connected between the pushed part 33 and the middle of the force-bearing rod segment 341. The two side wing rod segments 352 are respectively provided at opposite sides of the main rod segment 351. The side wing rod segments 352 extend obliquely away from the main rod segment 351 along the direction close to the force-bearing rod segment 341, and the end of the side wing rod segment 352 away from the main rod segment 351 is adjacent to the force-bearing rod segment 341. Thus, the structure is simple and easy to implement.

In an embodiment, in the first stage when the temple 102 is flipped outward from the open position, the limiting member 40 pushes against the pushed part 33 through the limiting part 41, so as to cause the main rod segment 351 to apply pressure to the middle of the force-bearing rod segment 341. The force-bearing rod segment 341 and the bending rod segment 342 undergo elastic deformation, and the elastic deformation of the bending rod segment 342 mainly provides the main elastic force (i.e., the first force) to the pushed part 33. At this time, the direction of the first force is from the mounting part 31 to the pushed part 33, and is transmitted to the pushed part 33 through the main rod segment 351.

In the second stage of the temple 102 flipping outward from the open position, the deformable space of the bending rod segment 342 becomes limited, causing the force-bearing rod segment 341 to gradually increase its contribution to the elastic force (i.e., the first force), and causing the two ends of the force-bearing rod segment 341 to gradually approach and abut against the first end of the side wing rod segment 352. Since the second end of the side wing rod segment 352 is fixed to the main rod segment 351 and constrained by the main rod segment 351, the first end of the side wing rod segment 352 will undergo elastic deformation around its second end after being pushed by the end of the force-bearing rod segment 341. The elastically deformed side wing rod segment 352 will generate a reaction force on the main rod segment 351. This reaction force is transmitted to the pushed part 33 through the main rod segment 351 and manifests as the elastic force of the side wing rod segment 352 on the pushed part 33 (i.e., the second force). At this time, the direction of the second force is from the pushed part 33 towards the mounting part 31.

It can be understood that the side wing rod segment 352 does not deform elastically in the first stage, but begins to deform elastically in the second stage. The elastic force (i.e., the second force) generated by the side wing rod segment 352 on the pushed part 33 can offset the increase in elastic force (i.e., the first force) caused by the further deformation of the force-bearing rod segment 341 and the bending rod segment 342. This allows the reaction force applied by the pushed part 33 to the limiting part 41 to be maintained at a certain value, and manifests as a constant clamping force of the temple 102 flipping outward.

As shown in FIG. 8 and FIG. 10, in an embodiment, the plane where the midpoint connecting line of the deformation part 32 is located intersects with the first axis. The deformation part 32 includes a first arc-shaped rod segment 361 and a second arc-shaped rod segment 362, protrusions of the first arc-shaped rod segment 361 and second arc-shaped rod segment 362 are in opposite directions. The first arc-shaped rod segment 361 is connected to the mounting part 31, and the second arc-shaped rod segment 362 protrudes toward the first axis. When the temple 102 is in the open position, the end of the second arc-shaped rod segment 362 away from the first arc-shaped rod segment 361 is abutted against the limiting part 41.

As shown in FIG. 8, in an embodiment, the limiting part 41 extends along the direction of the first axis and the end of the limiting part 41 is connected to the first bracket 10. In the embodiment where the second bracket 20 includes a second rotating portion 21, both ends of the limiting part 41 are respectively connected to the second rotating portion 21. Thus, the limiting part 41 has a simple structure and is easy to implement. In an embodiment, in the embodiment, the limiting part 41 is integrally formed with the second bracket 20. This simplifies the manufacturing process of the temple connection structure 101 and improves production efficiency.

As shown in FIG. 1, FIG. 6, and FIG. 8, in some embodiments, a second elastic member 50 is further provided between the first bracket 10 and the second bracket 20. The second elastic member 50 elastically deforms along the direction of the first axis and is in an elastic deformation state at least during the process of the temple 102 flipping inward from the open position. Thus, the second elastic member 50 is clamped and compressed by the first bracket 10 and the second bracket 20. During the process of the temple 102 flipping inward from the open position, the compressed second elastic member 50 will generate dynamic friction with the contact surfaces of the first bracket 10 and the second bracket 20, providing damping force to the first bracket 10 and the second bracket 20 during rotation, preventing the temple 102 from swinging arbitrarily during the handling and transfer of the device, that is, maintaining the posture of the temple 102. In an embodiment, the second elastic member 50 may not be provided.

In an embodiment, the second elastic member 50 is configured as a disc spring. In other embodiments, a corrugated spring or other elastomers such as silicone bodies may also be used as the second elastic member 50.

As shown in FIG. 1, FIG. 6, and FIG. 8, in an embodiment where the first bracket 10 includes a first rotating portion 11 and the second bracket 20 includes a second rotating portion 21, the second elastic member 50 is provided between the first rotating portion 11 and the second rotating portion 21. This results in a simple structure that is easy to assemble. In other embodiments, the second elastic member 50 may also be provided at other locations on the first bracket 10 and the second bracket 20.

As shown in FIG. 9 and FIG. 10, the present application also proposes a head-mounted display device, the head-mounted display device includes a frame 103, temples 102, and the aforementioned temple connection structure 101. The specific structure of the temple connection structure 101 is as described in the above embodiments. Since the head-mounted display device adopts all the technical solutions of all the above embodiments, it has at least all the beneficial effects brought about by the technical solutions of the above embodiments, which will not be described in detail here. The temples 102 are mounted at the frame 103 through the temple connection structure 101.

Furthermore, when the temple 102 is in the open position, a clearance gap 106 is formed between the temple 102 and the frame 103. The head-mounted display device further includes a cover 105 provided in the clearance gap 106 to cover at least a portion of the temple connection structure 101 exposed in the clearance gap 106. Thus, the cover 105 can both protect the portions of the temple connection structure 101 and the functional member 104 exposed in the clearance gap 106 and improve the neatness and aesthetics of the head-mounted display device at the connection point of the temple 102. In an embodiment, the cover 105 may not be provided.

In an embodiment, as shown in FIG. 11, when the temple 102 is in the outward limit position, the inner side of the temple 102 is abutted against the frame 103, thereby constraining the limit position of the temple 102. At this time, the clearance gap 106 is zero clearance on the inner side of the temple 102.

To further enhance the protective performance of the cover 105, the cover 105 extends circumferentially around the rotation axis of the first bracket 10. The cover 105 includes a first cover 105a and a second cover 105b joined together, with the first cover 105a and the second cover 105b respectively provided at opposite sides of the clearance gap 106. That is, the cover 105 shields the inner and outer sides of the clearance gap 106, thereby improving its protective effect and further enhancing the aesthetics of the device. In an embodiment, the cover 105 may only be provided at one side of the clearance gap 106.

There are various ways to mount the cover 105 and the temple connection structure 101, and the present application does not limit them. For example, the first cover 105a can be mounted at the first bracket 10 or the second bracket 20 by snap-fit and/or screw-fit, and the second cover 105b can be mounted at the first cover 105a by welding or bonding.

The above description is merely an exemplary embodiment of the present application and does not limit the scope of the present application. Any equivalent structural transformations made based on the technical concept of the present application and the description and drawings, or direct/indirect applications in other related technical fields, are included within the scope of the present application. Although some embodiments of the present application have been described, those skilled in the art, once they understand the basic inventive concept, can make other changes and modifications to these embodiments. Therefore, the appended claims are intended to be interpreted as including the embodiments as well as all changes and modifications falling within the scope of the present application.

The above description is merely an exemplary embodiment of the present application and does not limit the scope of the present application. Any equivalent structural transformations made based on the content of the specification and drawings of the present application under the concept of the present application, or direct/indirect applications in other related technical fields, are included within the scope of the present application.

What is claimed is:

1. A temple connection structure configured for connecting a temple and a frame, comprising:
a first bracket;
a second bracket rotatably connected to the first bracket;
a first elastic member provided at the first bracket; and
a limiting member provided at the second bracket and provided with a limiting part,
wherein one of the first bracket and the second bracket is mounted at the temple and the other of the first bracket and the second bracket is mounted at the frame; and
during a process of the temple flipping outward from an open position, the limiting part pushes against the first elastic member and causes the first elastic member to be in an elastic deformation state.

2. The temple connection structure according to claim 1, wherein the first bracket and the second bracket rotate relative to each other around a first axis, and an elastic deformation direction of the first elastic member intersects with the first axis.

3. The temple connection structure according to claim 2, wherein the first elastic member and the limiting member are provided at a side of the first axis, the first bracket and the second bracket form a mounting channel at the first axis, and the mounting channel is configured for a functional member to extend from the frame to the temple.

4. The temple connection structure according to claim 3, wherein, during a process of the temple flipping inward from the open position, the limiting part disengages from the first elastic member, and a clearance space is formed between the first elastic member and the limiting part; the clearance space is communicated with the mounting channel, and the functional member is partially accommodated in the clearance space.

5. The temple connection structure according to claim 1, wherein the first elastic member comprises a mounting part, a deformation part and a pushed part connected in sequence, the mounting part is connected to the first bracket, and the pushed part moves toward the mounting part under a pushing action of the limiting part, and causes the deformation part to elastically deform.

6. The temple connection structure according to claim 5, wherein a plane where a midpoint connecting line of the deformation part is located is parallel to the first axis, the limiting member further comprises two cantilever parts intersecting with each other, first ends of the two cantilever parts are respectively connected to different positions of the first bracket, second ends of the two cantilever parts are connected to each other and connected to the limiting part, and the two cantilever parts and the limiting part are provided at the plane.

7. The temple connection structure according to claim 5, wherein the deformation part comprises a first deformation structure and a second deformation structure connected to the first deformation structure, the first deformation structure is connected to the mounting part, the second deformation structure is connected to the pushed part, and the process of the temple flipping outward from the open position comprises a first stage and a second stage occurring sequentially; in the first stage, the first deformation structure deforms while the second deformation structure does not deform; in the second stage, the first deformation structure and the second deformation structure deform, and elastic forces applied to the pushed part by the first deformation structure and the second deformation structure are provided in opposite directions to keep an amplitude fluctuation of a clamping force of the temple within a preset percentage.

8. The temple connection structure according to claim 7, wherein the first deformation structure comprises a force-bearing rod segment and two bending rod segments, the two bending rod segments are respectively provided at opposite ends of the force-bearing rod segment, the force-bearing rod segment is opposite to the mounting part, and one end of the bending rod segment is connected to an end of the force-bearing rod segment, and the other end of the bending rod segment is connected to an end of the mounting part; the second deformation structure comprises a main rod segment and two side wing rod segments, the main rod segment is connected between the pushed part and a middle of the force-bearing rod segment; the two side wing rod segments are respectively provided at opposite sides of the main rod segment, the side wing rod segments extend obliquely away from the main rod segment along a direction close to the force-bearing rod segment, and an end of the side wing rod segment away from the main rod segment is adjacent to the force-bearing rod segment.

9. The temple connection structure according to claim 5, wherein a plane where a midpoint connecting line of the deformation part is located intersects with the first axis, the deformation part comprises a first arc-shaped rod segment and a second arc-shaped rod segment, protrusions of the first arc-shaped rod segment and second arc-shaped rod segment are in opposite directions, the first arc-shaped rod segment is connected to the mounting part, and the second arc-shaped rod segment protrudes toward the first axis; when the temple is in the open position, an end of the second arc-shaped rod segment away from the first arc-shaped rod segment is abutted against the limiting part.

10. The temple connection structure according to claim 1, wherein a second elastic member is provided between the first bracket and the second bracket, the second elastic member elastically deforms along a rotation axis of the first bracket, and is in the elastic deformation state at least during a process of the temple flipping inward from the open position.

11. A head-mounted display device, comprising:
a frame;
temples; and
a temple connection structure according to claim 1,
wherein the temples are mounted at the frame through the temple connection structure.

12. The head-mounted display device according to claim 11, wherein when the temple is in an open position, a clearance gap is formed between the temple and the frame, and the head-mounted display device further comprises a cover provided in the clearance gap to cover at least a portion of the temple connection structure exposed in the clearance gap.
